(19) United States
(12) Patent Application Publication
(10) Pub. No.: US 2026/0238038 A1
(43) Pub. Date: Aug. 13, 2026

(54) THE SYSTEM, DEVICE AND PROCEDURE IN DYNAMIC OPTIMISATION AND STABILISATION OF THE ELECTRICAL GRID USING A MULTILEVEL ADDITIVE-INCREASE/MULTIPLICATIVE-DECREASE (AIMD) METHOD

(71) Applicant: ISKRAEMECO, MERJENJE IN UPRAVLJANJE ENERGIJE, D.D., Kranj (SI)

(72) Inventors: Tomaz Dostal, Moravce (SI); Uros Bizjak, Sencur (SI); Gregor Rodic, Krize (SI); Jure Germovsek, Krize (SI)

(21) Appl. No.: 19/153,858

(22) PCT Filed: Dec. 1, 2023
(86) PCT No.: PCT/SI2023/050020

§ 371 Date: Aug. 5, 2025

(30) Foreign Application Priority Data
Feb. 6, 2023 (SI) P-202300022

(51) Int. Cl. H02J 13/182; G05B 6/02; H02J 13/12

(52) U.S. Cl. CPC H02J 13/182; G05B 6/02; H02J 13/12

(57) ABSTRACT

The system, device and procedure for dynamic optimisation and stabilisation of the electrical grid by using a multilevel method of Additive-Increase/Multiplicative-Decrease—the AIMD method of the invention enable automatic dynamic regulation of the electrical grid with the aim of dynamically balancing the energy generation and demand in the entire electrical grid to prevent grid overload while still delivering the maximum power demanded by consumers in a specific moment. The advantage of the invented procedure is that the regulation is performed with simple algorithms, which require low processing power and may be executed decentralized on several levels, which reduces the complexity of each specific algorithm. As per the invention, the technical problem is solved by using the AIMD algorithm on at least two levels of the electrical grid: at least on the level of individual consumption points, and the level of low voltage transformers, where every AIMD server executes the first part of the AIMD algorithm, and every AIMD consumer executes the second part of the AIMD algorithm. In this way, the system and procedure of the invention enable more stable and responsive management and regulation of the electrical grid.

### INTRODUCTION

A state-of-the-art smart electrical grid comprises a number of components, such as sensors, actuators, measuring instruments for physical quantities related to the grid status and its surroundings, information links, as well as information and management systems. The purpose of having a smart grid is to enable monitoring, control, and communication within the energy supply chain to increase the operational efficiency, reduce energy losses, optimise the energy supply and loads on the generation side, as well as to reduce costs and increase the operational reliability.

With technology advances and the increasing significance of environment protection, the electrification has been greatly intensified. Specifically, the amount of electric and electronic devices has increased greatly: ranging from basic electrical gadgets to electronically controlled actuators in all parts of life, telecommunication networks and devices, electric heating and cooling devices, such as heat pumps, heating panels, air conditioners, and last but not least, electric vehicles and charging stations. The electricity demand and the complexity of supplying sufficient energy in all grid levels without overloads has dramatically increased by this myriad of devices. The grids are getting increasingly overloaded and diversly challenged, stretching them to their operational limits and reducing their stability. The instability is further increased by the rising number of dispersed alternative electricity sources (e.g. photovoltaic panels and wind turbines), which due to their unpredictable operation contribute to the grid destabilisation.

### THE CURRENT STATE OF THE ART

Modern state-of-the-art electrical grids incorporate progressively more connected smart devices. For instance, at the consumption point level, the electrical grid contains a smart meter, which is connected to a central server and other smart devices in the grid through a common communication network. The smart meter at the consumption point, besides measuring and recording the total energy consumption of individual consumers connected to this consumption point, measures also the instantaneous net power of the consumption point, i.e. the sum of net powers of individual consumers at this consumption point and any losses. The smart meter also provides processing and memory resources to log relevant data and to execute applicable algorithms as well as communication resources to connect with the central communication network.

Similarly, at the medium voltage/low voltage (MV/LV) transformer level, which transforms grid MV into LV and to which various individual consumption points are connected, the state-of-the-art electrical grid contains a smart meter at the MV/LV transformer. Besides measuring and recording the total energy demand at individual consumption points connected to the MV/LV transformer, the smart meter at the MV/LV transformer measures also the instantaneous net power of this MV/LV transformer, i.e. the sum of net powers of the connected consumption points and any losses. The smart meter also provides processing and memory resources to log relevant data and execute applicable algorithms, and provides communication resources to connect with the central communication network.

Equivalently, the electrical grid at the high voltage/medium voltage (HV/MV) transformer level, which transforms the grid voltage from HV to MV, is also equipped with a smart meter at the HV/MV transformer, which measures and records the total energy consumption of individual MV/LV transformers connected to the specific HV/MV transformer, the instantaneous net power of the HV/MV transformer (i.e. the sum of net powers of connected individual MV/LV transformers and any losses). The smart meter also provides processing and memory resources to log relevant data and execute applicable algorithms, as well as communication resources to connect with the central communication network.

Likewise, at the level of an individual HV branch with several connected HV/MV transformers, the electrical grid utilizes smart meters to measure and record the total electricity consumption of individual HV/MV transformers connected to the specific HV branch, the instantaneous net power of the HV branch (i.e. the sum of net powers of connected individual HV/MV transformers and any losses). The smart meters also provide processing and memory resources to log relevant data and execute applicable algorithms, as well as communication resources to connect with the central communication network.

The above-described environment enables centralization of modern smart grids, which in theory allows for controlled, regulated and balanced operation, but at the same time it has proved to be too complex for efficient centralised control. Due to the task complexity, centralised control is resulting in delayed reactions to demand variations or operational changes on a specific grid level or branch.

To maintain stable operation of the electrical grid, the balance between energy generation and demand is crucial. This has proved to be extremely difficult to achieve due to the considerable number of generators and consumers (consumption points)—in other words, the highly branched and complex electrical grid.

So far used solutions in electrical grid control and regulation that aimed at balancing the grid generation and demand have been based on centralised processing of generation and demand data as well as grid status data that might affect the energy transfer in the grid (e.g. ambient temperature, wind), outages of certain grid sections, projected increase/decrease in electricity generation etc. Based on this data, which is sent to the central server through the common communication network, algorithms are used to define measures to connect/disconnect individual consumers, transformer stations, electrical grid branches or even specific energy generators. To balance the demand and generation, modern solutions use sophisticated artificial intelligence (AI) procedures to control and regulate the electrical grid, such as neural networks, machine learning, genetic algorithms etc. These AI procedures significantly improve the control and regulation of the electrical grid and are possible due to scaling processing power, data storage capacities in central servers and increased information flow in the central communication network required to run these procedures. One of the common features in state-of-the-art solutions for electrical grid control is centralised access, which requires the status of the entire electrical grid to be available on one single central server (usually, this is the centre which controls, collects, distributes, and processes data). Centralised control of such a complex electrical grid is extremely demanding and because of the centralization also more vulnerable to incidents, either physical or cyber, threats that may damage the infrastructure, lead to privacy breaches, operational disruptions, or service unavailability.

Due to the grid complexity, rapid variations in electricity demand or unpredictable incidents, centrally executed processes may be too slow in regulating the electrical grid, causing network instabilities and/or suboptimal operation. A comprehensive overview of AI adoption in modern smart grids is available in article [1] (State-of-the-Art Artificial Intelligence Techniques for Distributed Smart Grids: A Review, Syed Saqib Ali in Bong Jun Choi, Electronics 2020, 9 (6)).

The increase in electricity consumers, especially electrical vehicle (EV) charging stations, heat pumps, air conditioners and similar loads, is further increasing the complexity of the above-described algorithms for balancing the demand in smart grids. For instance, consumers wish to charge their EVs in forecasted or even non-forecasted time windows, or, due to temperature changes, turn on their heating or cooling devices on a massive scale, which may cause dramatic variations in grid load. Even at the consumption point level, such consumers may cause fuse overload in their home wiring.

A useful solution to balance the grid demand has been presented in article [2] (Investigation of AIMD Based Charging Strategies for EVs Connected to a Low-Voltage Distribution Network, Mingming Liu et al, Conference: Innovative Smart Grid Technologies Europe (ISGT EUROPE), 2013 4th IEEE/PES), where the available power to charge an EV is defined by using an Additive-Increase and Multiplicative-Decrease (AIMD) algorithm. The AIMD algorithm is common in Transmission Control Protocol (TCP), where it is used to additively increase the actual data transmission rate in the subsequent time window until the quantity of transferred data does not reach the preset maximum value. At that point, the transmission rate in the subsequent time window is decreased by a multiplicative factor (exponential reduction), but only after executing an intermediate step which introduces a factor of randomness to prevent rapid transmission reduction. This approach adjusts the data transmission rate by allowing for the largest possible rate and, at the same time, prevents the maximum value to be exceeded, which would cause transmission congestion. All this is achieved by using a relatively simple algorithm, which does not demand high processing power.

In article [2], the described AIMD method of limiting electric power to connected EV charging stations increases the operational stability of the smart grid by lowering the peak power demand while still achieving the available power capacity, measured at a LV transformer, and multiplicatively reduces the available power to all EV charging stations connected to that specific transformer. The weakness of this single level algorithm is that it does not take into account other smart consumers in individual houses which are connected to the consumption point behind the residential smart meter and may, with unregulated consumption, cause high power demand peaks (e.g. heat pumps, refrigerators, ovens, home EV charging stations etc.). There is a high probability that individual consumption points, which may be equipped with renewable energy sources (e.g. photovoltaic cells), cause operational instability in the local grid due to the unregulated power generation and demand at the consumption point. Consequently, this also triggers instability in the distribution power grid. Therefore, the described method fails at managing and regulating the complete or majority of the electrical grid.

### The Description of the Invention

The purpose of this invention is to propose a system, device, and procedure, which enable robust automated dynamic regulation of the electrical grid operation with the aim of dynamically balancing the energy generation and demand in the entire electrical grid. If needed, the invention may adjust the grid operation by considering the ambient temperature and other factors that might affect the capacity of a specific transformer, grid branch or grid level. This prevents grid overload while still delivering the maximum power demanded by consumers in a specific moment. The advantage of the invented procedure is that it uses relatively simple algorithms, which require rather low processing power, and may be executed decentralized on several levels, which reduces the complexity of each specific algorithm. In this way, the invented system and procedure enable more stable and responsive management and regulation of the electrical grid.

The invention's technical problem is solved by using an AIMD algorithm on at least two levels of the electrical grid: at least on the level of individual consumption points and the level of low voltage transformers.

Below, we explain the invention in detail using figures to present examples of implementation:

FIG. 1: A schematic view of the lowest level of AIMD Cluster A21 on the individual consumption point level with Smart consumers 11, 12, 13, . . . , 1n;

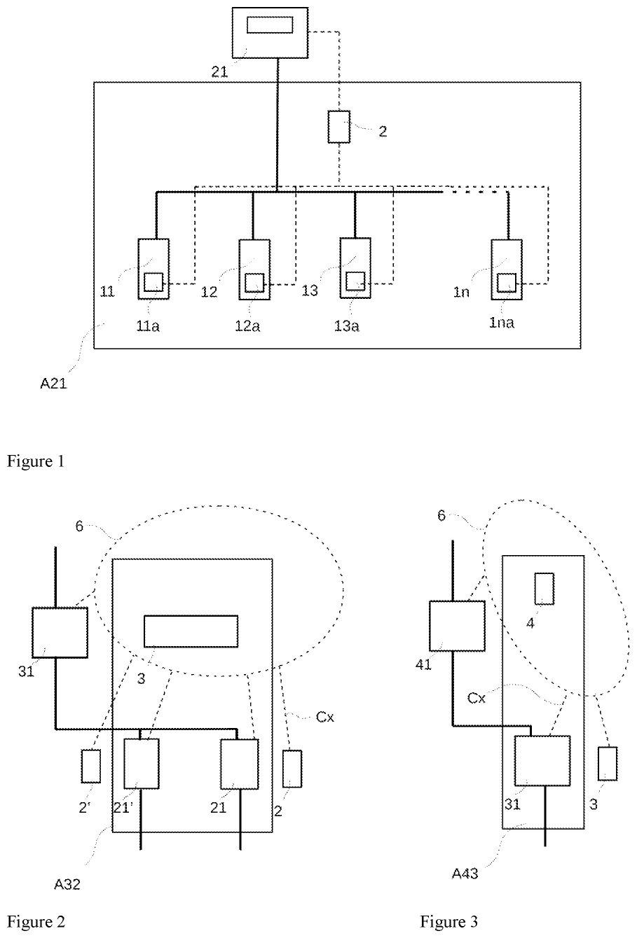

FIG. 2: A schematic view of the second level of AIMD Cluster A32, which corresponds to the low voltage grid, or the level of an individual MV/LV transformer with Smart meter 31, to which various consumption points are connected with their relevant Smart meters 21 and 21′;

FIG. 3: A schematic view of the third level of AIMD Cluster A43, which corresponds to the medium voltage grid, or the level of an individual HV/MV transformer equipped with Smart meter 41, to which various MV/LV transformers are connected with their relevant Smart meters 31;

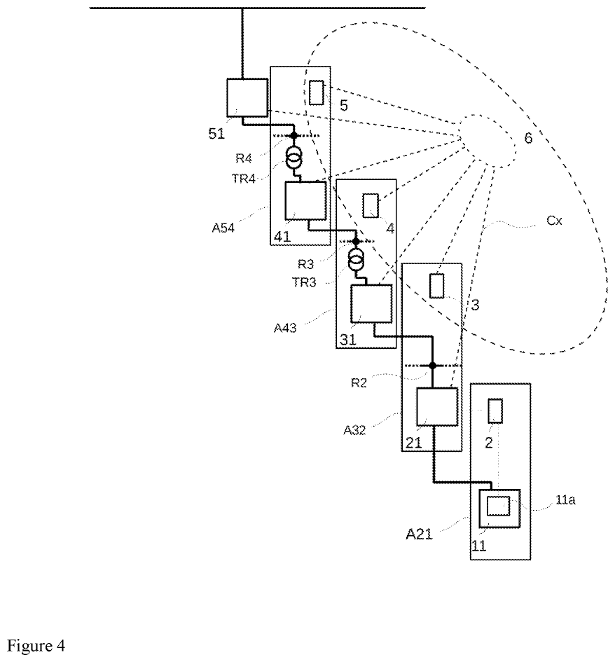

FIG. 4: A schematic view of a multilevel cascade of AIMD clusters and their placement in the electrical grid. For reasons of clarity, only one AIMD consumer is shown for each level or AIMD cluster.

At each level, the AIMD algorithm is executed by using an AIMD Cluster (A21, A32, A43, A54), which contains an AIMD Server (2, 3, 4, 5), and at least one AIMD Consumer (11, 12, . . . , 1n, 21, 21′, 31, 41), which has a communication link with relevant AIMD Servers 2, 3, 4, 5.

As shown in FIG. 1, AIMD Cluster A21 on the individual consumption point level contains AIMD Server 2, which is implemented as a demand facility, while AIMD Consumers 11, 12, 13, . . . , 1n are smart consumers at this consumption point. The grid level at which the AIMD server is implemented defines the level of the entire AIMD cluster, because the AIMD consumer in this cluster is functionally on a lower level than the AIMD server.

The Demand facility 2 has its own processing and memory resources to execute the first part of the AIMD algorithm and communication resources to connect with Smart meter 21 at the consumption point and AIMD Consumers 11, 12, 13, . . . , 1n (smart consumers). An alternative implementation allows for AIMD Server 2 on this level to be implemented as a software module, which is executed on Smart meter 21 at this consumption point or on Central server 6, where Smart meter 21 is connected to Central server 6 over the common Communication network Cx.

Besides the hardware which provides basic user functionality (e.g. an EV charging station), each Smart consumer 11, 12, 13, . . . , 1n has a relevant smart module (11a, 12a, 13a, . . . , 1na), which has the processing and memory resources to execute the second part of the AIMD algorithm, a regulation element to regulate the power at the specific smart consumer, which is connected to the said processing and memory resources, and communication resources to connect with relevant AIMD Server 2 (see FIG. 1).

As shown in FIG. 2, AIMD Cluster A32 on the level of an individual MV/LV transformer, to which individual consumption points are connected, contains AIMD Server 3, implemented as a software module running on Central server 6 to execute the first part of the AIMD algorithm. AIMD Consumers 21, 21′ are smart meters at consumption points, which are connected to the MV/LV transformer. The second part of the AIMD algorithm is executed on Smart meters 21, 21′ at above consumption points.

FIG. 3 shows AIMD Cluster 43 on the level of an individual HV/MV transformer, to which several MV/LV transformers are connected. AIMD Cluster 43 contains AIMD Server 4, which is implemented as an AIMD software module running on Central server 6 to execute the first part of the AIMD algorithm. AIMD Consumers 31 (for clarity reasons, only one consumer is shown) are Smart meters 31, which belong to individual MV/LV transformers connected to the HV/MV transformer. The second part of the AIMD algorithm is executed on Smart meters 31 at the MV/LV transformers.

FIG. 4 shows four AIMD Clusters: A21, A32, A43 and A54, each on a separate level. The first three AIMD Clusters, A21, A32, and A43, are individually described in FIGS. 1, 2 and 3 above. This figure additionally shows AIMD Cluster A54 on the level of a specific HV branch, to which several HV/ML transformers TR4 are connected. HV/MV transformer TR4 is not part of AIMD Cluster A54, as might be implied in FIG. 4, but is depicted as such only for the sake of simplicity; the same is true for MV/LV transformer TR3, which is again not part of AIMD Cluster A43.

Although Smart meter 51 of the specific HV branch is not part of AIMD Cluster A54, it is crucial for the operation of this cluster, which we explain in detail below. The smart meter measures and records the total energy consumption of individual HV/MV transformers TR4, which are connected to the specific HV branch, as well as the instantaneous net power of this HV branch (i.e. the sum of net powers of connected individual HV/MV transformers TR4 and losses, if any). It also has the processing and memory resources to record relevant data and execute applicable algorithms, and communication resources to connect with the central communication network.

AIMD Cluster A54 contains AIMD Server 5, which is implemented as an AIMD software module running on Central server 6 to execute the first part of the AIMD algorithm. In this cluster, AIMD Consumers 41 are Smart meters 41, which belong to specific HV/MV transformers TR4, connected to the HV branch through hub R4. The second part of the AIMD algorithm is executed on Smart meters 41 at above HV/MV transformers TR4. For transparency reasons, the figure shows only one AIMD consumer-Smart meter 41.

Hub R4 shows that this HV branch may have several connected HV/MV transformers TR4, of which Smart meters 41 function as AIMD consumers of AIMD Cluster A54. Hub 3 illustrates that a single HV/MV transformer TR4 may have several connected MV/LV transformers TR3, of which Smart meters 31 function as AIMD consumers of AIMD Cluster A43. Hub R2 shows that one MV/LV transformer TR3 may have several connected consumption points, of which Smart meters 21 function as AIMD consumers of AIMD Cluster A32.

The previously mentioned AIMD Servers 2, 3, 4 and 5, which are above described as being implemented as software modules on the central server, may alternatively be implemented as software modules running on a smart meter or another relevant local processing device since the first part of the AIMD algorithm, which is executed by AIMD servers, is relatively simple. For instance, AIMD Server 5 may be implemented as a software module on Smart meter 51 or on a local processing device that belongs to Smart meter 51. Further on, AIMD Server 4 may be implemented as a software module on Smart meter 41 or on a local processing device belonging to Smart meter 41; AIMD Server 3 may be implemented as a software module on Smart meter 31 or on a local processing device belonging to Smart meter 31; and AIMD Server 2 may be implemented as a software module on Smart meter 21 or on a local processing device belonging to Smart meter 21.

The mentioned Smart meters 21, 21′, 31, 41, 51 are connected to Central server 6 over the common Communication network Cx.

We will describe the execution of the AIMD algorithm on a specific level or in a specific AIMD cluster first on the level of an individual consumption point as shown in FIG. 1.

The consumption point, e.g. an individual house, has Smart meter 21, which is not part of AIMD Cluster A21 on the consumption point level. Instead, it is part of AIMD Cluster A32, which is one level higher (FIG. 2), i.e. the level of MV/LV transformer TR3. The consumption point has a predefined fixed maximum power, P_{S2max}, which is defined by technical and contract conditions valid for this consumption point. The P_{S2max} is, in one of the implementation variants, stored in Smart meter 21. The smart meter stores also the dynamic maximum power in the relevant time window P_{D2max}(t). Additionally, Smart meter 21 also records the instantaneous power consumption P₂ at the consumption point. On AIMD Server 2, which from Smart meter 21 receives data on the instantaneous power P₂ and the dynamic maximum power in the relevant time window P_{D2max}(t), the following steps of the first part of the AIMD algorithm are executed:
if P₂<P_{D2max}, then AIMD Server 2 assigns the value 0 to control parameter c₂ (c₂=0);
if P₂≥P_{D2max}, then AIMD Server 2 assigns the value 1 to control parameter c₂ (c₂=1);
where the value of control parameter c₂ in the relevant time window t is sent to all AIMD Consumers 11, 12, 13, . . . 1n at this consumption point, i.e. all smart consumers or their relevant Smart modules 11a, 12a, 13a, . . . 1na.

If the control parameter c has a value of c₂=0, AIMD Consumers 11, 12, 13, . . . 1n typically interpret this as a signal to increase the power. And contrary, a control parameter c value of c₂=1 gives a signal to AIMD Consumers 11, 12, 13, . . . 1n to reduce the power.

Every AIMD Consumer 11, 12, 13, . . . 1n has information on its fixed maximum power P_{S1max}, which depends on the consumer's technical characteristics, and its dynamic maximum power in the relevant time window P_{D1max}(t), which has been calculated in the previous time window. The dynamic maximum power in the relevant time window P_{D1max}(t) limits the net power to the consumer using a regulation element.

When every AIMD Consumer 11, 12, 13, . . . 1n receives control parameter c₂, the consumer executes the second part of the AIMD algorithm, depending on the control parameter's value:
a) If c₂=0 and P_{D1max}(t)<P_{S1max}, then the dynamic maximum power in the subsequent time window P_{D1max}(t+Δt) is increased by the additive constant α1 (P_{D1max}(t+Δt)=P_{D1max}(t)+α₁), otherwise the power P_{D1max} remains unchanged.
   In other words, only when the dynamic maximum power P_{D1max}(t) is lower than the fixed maximum power P_{S1max}, the dynamic maximum power will be increased in the subsequent time window P_{D1max}(t+Δt); otherwise, the dynamic maximum power in the subsequent time window P_{D1max}(t+Δt) is equal to the maximum dynamic power in the relevant time window P_{D1max}(t), even though the control parameter is c₂=0, which would typically imply a power increase. In this way, the consumer is protected so that its net power never exceeds its fixed maximum power P_{S1max}. The additive constant α1 represents the increment in dynamic maximum power P_{D1max}, and is typically defined as a specific percentage of the fixed maximum power P_{S1max}, for instance, between 5 and 10% of P_{S1max}.
b) If c₂=1, the dynamic maximum power in the subsequent time window P_{D1max}(t+Δt) is decreased based on the randomly generated parameter γ₁ with a random value between 0 and 1. The randomly generated parameter γ₁ is compared to the predefined probability areas to determine which predefined probability area is relevant in this time window. Each probability area has a corresponding predefined multiplicative decrease factor β₁ₙ, which is used to reduce the dynamic maximum power in the subsequent time window P_{D1max}(t+Δt). Every multiplicative decrease factor β₁ₙ is larger than 0 and typically smaller than 1, but may in some instances equal 1; in that case, P_{D1max}(t+Δt) equals P_{D1max}(t). To illustrate, we will introduce an implementation example, in which we have two predefined probability areas with respective multiplicative factors β₁₁ and β₁₂, where the probability areas are demarcated with a predefined parameter γ₁₀. To define the probability of decrease for a specific multiplicative decrease factor (β₁₁ or β₁₂), the following is done:

$$\begin{matrix}i . & \\ if {γ}_{1} < {γ}_{10} , then {P}_{D 1 max} ( t + Δ t ) = {P}_{D 1 max} ( t ) \cdot {β}_{11} ; & \end{matrix}$$

$$\begin{matrix}ii . & \\ otherwise , ( {γ}_{1} \geq {γ}_{10} ) is {P}_{D 1 max} ( t + Δ t ) = {P}_{D 1 max} ( t ) \cdot {β}_{12} . & \end{matrix}$$

It follows that if c₂=1, the dynamic maximum power P_{D1max} of AIMD Consumer 11, 12, 13, 1n is multiplicatively decreased by factor β₁₁ or β₁₂, depending on the randomly generated parameter γ₁. In this implementation variant, the typical values of γ₁₀ are between 0.85 and 0.95. For β₁₁, the typical value is selected in the range between 0.5 and 0.75, while for β₁₂, between 0.9 and 0.95.

By introducing randomness in the step of the dynamic maximum power decrease, we achieve that consumers do not react unanimously with an equal decrease to the decrease power signal (c₂=1), which might otherwise cause rapid fluctuations in the total net power.

The described second part of the AIMD algorithm is executed independently at each AIMD consumer, where each AIMD consumer has its own fixed maximum power P_{S1max} and calculates its own dynamic maximum power P_{D1max}.

In the following AIMD Cluster A32 on the MV/LV transformer TR3 level, its AIMD Server 3 for the semantically equal first part of the AIMD algorithm as described above, generates parameter c₃ and sends it to typically more than one AIMD Consumer 21, 21′, which are smart meters at consumption points that calculate their individual dynamic maximum power according to the above second part of the AIMD algorithm.

Every MV/LV transformer TR3 has a corresponding Smart meter 31, which is not part of AIMD Cluster A32 on this level. Instead, the smart meter is part of AIMD Cluster A43 on the HV/MV transformer TR4 level. MV/LV transformer TR3 has a predefined fixed maximum power P_{S3max}, which is defined based on the technical conditions valid for this MV/LV transformer TR3. The fixed maximum power P_{S3max} may also depend on environmental factors, such as the ambient temperature. If the ambient temperature is high, the transformer is not cooled optimally, hence the fixed maximum power P_{S3max} is lower than in colder conditions. Similarly, the temperature affects the fixed maximum power P_{S3max} through line losses because the higher the temperature, the higher the line losses.

The fixed maximum power P_{S3max} may, depending on the implementation variation, be stored in Smart meter 31 and/or in Central server 6. Similarly stored is also the dynamic maximum power P_{D3max}(t) in the relevant time window, which was calculated in the previous time window. Besides, Smart meter 31 measures the instantaneous power consumption P₃ at this MV/LV transformer TR3. On AIMD Server 3, which receives data on the instantaneous power P3 and the dynamic maximum power in the relevant time window P_{D3max}(t), the following steps of the first part of the AIMD algorithm are executed:
if P₃<P_{D3max}, then AIMD Server 3 assigns the value 0 to control parameter c₃ (c₃=0);
if P₃≥P_{D3max}, then AIMD Server 3 assigns the value 1 to control parameter c₃ (c₃=1);
where the value of control parameter c₃ in the relevant time window t is sent to all AIMD Consumers 21, 21′, i.e. individual Smart meters 21, 21′ at consumption points connected to this MV/LV transformer TR3.

As described above, the value of control parameter c₃=0 typically represents a signal for AIMD Consumers 21, 21′ to increase the power. And contrary, the value of control parameter c₃=1 is a signal for AIMD Consumers 21, 21′ to reduce the power.

Every AIMD Consumer 21, 21′ has information on its fixed maximum power P_{S2max} as described above, and its dynamic maximum power in the relevant time window P_{D2max}(t), which has been defined in the previous time window. The dynamic maximum power in the relevant time window P_{D2max}(t) affects the power in the electrical grid as it represents input data to calculate control parameter c₂ in the first part of the AIMD algorithm in AIMD Cluster 21 one level lower, as stated above.

When every AIMD Consumer 21, 21′ receives control parameter c₃, the Consumer executes the second part of the AIMD algorithm, depending on the control parameter's value:
a) If c₃=0 and P_{D2max}(t)<P_{S2max}, then the dynamic maximum power in the subsequent time window P_{D2max}(t+Δt) is increased by the additive constant α2 (P_{D2max}(t+Δt)=P_{D2max}(t)+ α₂), otherwise the power P_{D2max} remains unchanged.
   In other words, only when the dynamic maximum power P_{D2max}(t) is lower than the fixed maximum power P_{S2max}, the dynamic maximum power will be increased in the subsequent time window P_{D2max}(t+Δt); otherwise, the dynamic maximum power in the subsequent time window P_{D2max}(t+Δt) is equal to the maximum dynamic power in the relevant time window P_{D2max}(t), even though the control parameter is c₃=0, which would typically imply a power increase. In this way, the consumption point is protected so that its net power never exceeds its fixed maximum power P_{S2max}. The additive constant α₂ represents the increment in dynamic maximum power P_{D2max}, and is, similarly as α₁ above, typically defined as a specific percentage of the fixed maximum power P_{S2max}, for instance, between 5 and 10% of P_{S2max}.
b) If c₃=1, the dynamic maximum power in the subsequent time window P_{D2max}(t+Δt) is, similarly as above, decreased based on the randomly generated parameter γ₂ with a random value between 0 and 1. The randomly generated parameter γ₂ is compared to the predefined probability areas to determine which predefined probability area is relevant in this time window. Every probability area has a corresponding predefined multiplicative decrease factor β₂ₙ, which is used to reduce the dynamic maximum power in the subsequent time window P_{D2max}(t+Δt). As described above for multiplicative decrease factors β₁ₙ, the same is true for multiplicative decrease factors β₂ₙ, namely, that they are typically greater than 0 and smaller than 1, but in some cases also equal to 1. To define the probability of decrease for a specific multiplicative decrease factor (β₂ₙ), the following is calculated:

$${P}_{D 2 max} ( t + Δ t ) = {P}_{D 2 max} ( t ) \cdot {β}_{2 n}$$

where β₂ₙ is defined in relation to the probability area of the randomly generated parameter γ₂.

If c₃=1, the dynamic maximum power P_{D2max} of AIMD Consumer 21 (the smart meter at the consumption point) is multiplicatively decreased by the factor β₂ₙ depending on the randomly generated parameter γ₂.

In general, the second part of the AIMD algorithm is executed independently on every AIMD consumer, which is true also for AIMD Cluster A32. This means that every AIMD Consumer 21, 21′ has its fixed maximum power P_{S2max} and calculates its dynamic maximum power P_{D2max}.

The AIMD clusters on higher levels (AIMD Clusters 43 and 54) operate virtually the same, but with one difference: the AIMD cluster on the highest level—in this example, AIMD Cluster 54 (with AIMD Server 5)—does not receive the input data P_{D5max} for the first part of the AIMD algorithm from the AIMD cluster on the higher level as there is no higher level. To generate control parameter cs, instead of using the missing input data (P_{D5max}) for the first part of the AIMD algorithm, we compare the net power P₅ of this HV branch, which is measured by Smart meter 51 of this HV branch, to the fixed maximum power P_{S5max} of this HV branch. In other words—in such cases, the input data for the first part of the AIMD algorithm is the fixed maximum power P_{S5max} of this HV branch.

In general, every AIMD consumer within an AIMD cluster may have individual parameters defined, which are used in the second part of the AIMD algorithm, such as additive constant α, the probability areas and relevant multiplicative decrease factors β, or the parameters are identical in some or all of the AIMD consumers.

For all levels of AIMD Clusters A21, A32, A43, A54, the time window Δt is defined separately. On the first level, i. e. the consumption point level (AIMD Cluster A21), typically, Δt is between 1 s and 15 s, preferably 5 s. On the second level, i. e. the MV/LV transformer TR3 level (AIMD Cluster A32), the Δt values are typically between 1 min and 30 min, preferably 1-15 min, most typically 5 min. On the levels of HV/MV transformer TR4 (AIMD Cluster A43) and the HV branch (AIMD Cluster A54), the time windows Δt are typically 30 min.

In this way, we achieve that the information on the maximum power overrun (a comparison between the net power and the maximum power is made by the AIMD server in the first part of the AIMD algorithm) is transferred within the AIMD cluster downwards to AIMD consumers, which calculate their own dynamic maximum power. In AIMD clusters that have subordinate AIMD clusters on lower levels, the newly calculated dynamic maximum power of each individual consumer serves as input data for the comparison (the first part of the AIMD algorithm), which is executed by the AIMD server on the lower level. In this way, we can perform the power regulation on any number of grid levels and grid branches with significantly lower processing power, required for the regulation, and with the possibility of calculating the algorithms in specific AIMD clusters or even dispersed over the grid within the AIMD cluster. This enables to stabilize the power on the higher grid level through dynamic reduction of the allowed power on lower levels, by which we recursively achieve dynamic stabilisation of the power within the entire electrical grid or part of it.

The described system and procedure to stabilise the power in the electrical grid may be used for the entire grid or sections on two or more levels.

In general, the invented power regulation system contains at least two AIMD clusters on adjacent grid levels. The AIMD cluster consists of an AIMD server and an AIMD consumer, where the AIMD server grid level defines the level of the entire AIMD cluster because the AIMD consumer in this cluster is functionally on a lower level than the AIMD server.

Every AIMD server executes the first part of the AIMD algorithm, and every AIMD consumer executes the second part of the algorithm.

The first part of the AIMD algorithm is executed in the following way (where N represents the level of an individual AIMD server):
if the net power P_{N} on level N is lower than the dynamic maximum power P_{DNmax} (P_{N}<P_{DNmax}), then the AIMD server on level N assigns the value 0 to control parameter c_{N} (c_{N}=0);
if P_{N}≥P_{DNmax}, then the AIMD server on level N assigns the value 1 to control parameter c_{N} (c_{N}=1),
where the value of control parameter c_{N} in the relevant time window t is sent to all AIMD consumers within this AIMD cluster.

The second part of the AIMD algorithm is executed on individual AIMD consumers as follows:
a) If c_{N}=0 and the dynamic maximum power of AIMD consumers on level N−1, which are connected to the AIMD server on level N, in the relevant time window P_{D(N-1)max}(t) is lower than the fixed maximum power of these AIMD consumers P_{S(N-1)max} (P_{D(N-1)max}(t)<P_{S(N-1)max}), then the dynamic maximum power of these AIMD consumers in the subsequent time window P_{D(N-1)max}(t+Δt) is additively increased by additive constant α_{(N-1)} (P_{D(N-1)max}(t+Δt)=P_{D(N-1)}max(t)+α_{(N-1)}), otherwise the power P_{D(N-1)max} does not change.
b) If c_{N}=1, the dynamic maximum power in the subsequent time window P_{D(N-1)max}(t+Δt) is decreased, similarly as explained above, by the randomly generated parameter γ_{(N-1)} with a value between 0 and 1. The generated parameter γ_{(N-1)} is compared to the predefined probability areas to determine which predefined probability area is relevant in this time window. Each probability area has a corresponding predefined multiplicative decrease factor β_{(N-1)n}, where n stands for the relevant probability area. The decrease factor β_{(N-1)n} is used to reduce the dynamic maximum power in the subsequent time window P_{D(N-1)max}(t+Δt). Multiplicative decrease factors β_{(N-1)n} have a value greater than 0 and typically smaller than 1, but may in some instances equal 1. To define the probability of decrease for a specific multiplicative decrease factor (β_{(N-1)n}), the following is done:

$${P}_{D ( N - 1 ) max} ( t + Δ t ) = {P}_{D ( N - 1 ) max} ( t ) \cdot {β}_{( N - 1 ) n} ,$$

where β_{(N-1)n} is defined in relation to the probability area of the randomly generated parameter γ_{(N-1)}.

The value of the dynamic maximum power P_{D(N-1)max}(t+Δt), which is calculated by an AIMD consumer from an AIMD cluster on level N, represents input data for the AIMD server contained in the AIMD cluster on the lower level N−1 to execute the first part of AIMD algorithm, when P_{D(N-1)max} is compared to net power P_{(N-1)}.

The net power P_{N}, P_{N-1} on a specific N, N−1 level is measured with a smart meter on this level.

In general, the additive constant α_{(N-1)} may represent 5-10% of the fixed maximum power P_{S(N-1)max}, which is equivalently true for each level.

1. A system for dynamic optimisation and stabilisation of an electrical grid by using a multilevel method of Additive-Increase/Multiplicative-Decrease-AIMD method, wherein said system is adjusted to regulate power in the electrical grid, which comprises at least two levels, as well as smart meters, characterized in that the system comprising at least two AIMD clusters on adjacent grid levels, wherein each AIMD cluster comprises an AIMD server and at least one AIMD consumer, wherein the grid level of the AIMD server defines the level of the entire AIMD cluster, and the AIMD consumer in this AIMD cluster is on the next lower level, wherein each AIMD server executes a first part of the AIMD algorithm and each AIMD consumer executes a second part of the AIMD algorithm,
wherein the first part of the AIMD algorithm is executed as follows and wherein N represents the level of an individual AIMD server:
if a net power P_{N} on level Nis smaller than a dynamic maximum power P_{DNmax}, that is P_{N}<P_{DNmax}, then the AIMD server on level N assigns a value 0 to a control parameter c_{N} (c_{N}=0);
if P_{N}≥P_{Dmax}, then the AIMD server on level N assigns a value 1 to the control parameter c_{N} (c_{N}=1),
wherein the value of the control parameter c_{N} in the relevant time window tis sent to all AIMD consumers within this AIMD cluster,
wherein the second part of the AIMD algorithm is executed as follows:
a) if c_{N}=0 and the dynamic maximum power of the AIMD consumers on level N−1, which are connected to the AIMD server on level N, in the relevant time window P_{D(N-1)max}(t) is lower than a fixed maximum power of these AIMD consumers P_{S(N-1)max}, that is P_{D(N-1)max}(t)<P_{S(N-1)max}, then the dynamic maximum power of these AIMD consumers in a subsequent time window P_{D(N-1)max}(t+Δt) is increased by an additive constant α_{(N-1)}, that is P_{D(N-1)max}(t+Δt)=P_{D(N-1)max}(t)+α_{(N-1)}, otherwise the power P_{D(N-1)max} does not change;
b) if c_{N}=1, the dynamic maximum power in the subsequent time window P_{D(N-1)max}(t+Δt) is decreased by using a randomly generated parameter γ_{(N-1)}, of which the random value is between 0 and 1, where the generated parameter γ_{(N-1)} is compared to a predefined probability space to determine which predefined probability space is relevant in this time window and wherein each probability space has a corresponding predefined multiplicative decrease factor β_{(N-1)n}, where n stands for the corresponding probability space, which is used to decrease the dynamic maximum power in the subsequent time window P_{D(N-1)max}(t+Δt), and the probability of decrease for a specific multiplicative decrease factor (β_{(N-1)n}) is calculated using a following equation:
$${P}_{D ( N - 1 ) max} ( t + Δ t ) = {P}_{D ( N - 1 ) max} ( t ) \cdot {β}_{( N - 1 ) n} ,$$
where β_{(N-1)n} is defined in relation to the probability space of the randomly generated parameter γ_{(N-1)},
wherein the value of the calculated dynamic maximum power P_{D(N-1)max}(t+Δt), which is calculated by the AIMD consumer, which belongs to the AIMD cluster on level N, represents input data for the AIMD server, which belongs to the AIMD cluster on a lower level N−1 to execute the first part of the AIMD algorithm when P_{D(N-1)max} is compared to the net power P_{(N-1)},
where the net power P_{N}, P_{N-1} on a specific level is measured using the smart meter on this level.

2. The system according to claim 1, characterized in that the additive constant α_{(N-1)} represents 5 to 10% of the fixed maximum power P_{S(N-1)max}.

3. The system according to claim 1, characterized in that the multiplicative decrease factors β_{(N-1)n} are greater than 0 and typically smaller than 1, and in some cases also equal to 1.

4. The system according to claim 1, characterised in that the electrical grid comprises a HV branch level with a smart meter (51), a level of HV/MV transformers (TR4) with related smart meters (41), a level of MV/LW transformers (TR3) with related smart meters (31), a level of consumption points with related smart meters (21, 21′), and a level of smart consumers (11, 12, 13, . . . , 1n).

5. The system according to claim 4, characterized in that the smart meters (21, 21′, 31, 41, 51) are connected with a central server (6) over a common communication network (Cx).

6. The system according to claim 4, characterized in that the time window Δt at the consumption point level is between 1 s and 15 s, preferably 5 s; on the level of a MV/LV transformer (TR3), the time window Δt is between 1 min and 30 min, preferably 5 min; on the level of a HV/MV transformer (TR4) and the HV branch, the time window Δt is preferably 30 min.

7. The system according to claim 4, characterized in that the AIMD server (2) on the consumption point level is implemented as a facility device (2), while the AIMD servers (3, 4, 5) on other levels are implemented as AIMD software modules running on the central server (6).

8. A device for dynamic optimisation and stabilisation of the electrical grid by using a multilevel method of Additive-Increase/Multiplicative-Decrease-AIMD method, wherein said device is a facility device used as AIMD server (2) in the system according to claim 1, characterized in that the device comprises processing and memory means to execute the first part of the AIMD algorithm, and communication means to connect with the smart meter (21, 21′) at the consumption point and AIMD consumers.

9. A procedure for dynamic optimisation and stabilisation of the electrical grid by using a multilevel method of Additive-Increase/Multiplicative-Decrease-AIMD method, wherein the procedure is adapted for power regulation in the electrical grid and is being executed in the system according to claim 1, and wherein the procedure includes the following:
execution of the AIMD algorithm in two steps; where the electrical grid contains at least two AIMD clusters on adjacent grid levels, where every AIMD cluster consists of an AIMD server and at least one AIMD consumer, where the grid level of the AIMD server defines the level of the entire AIMD cluster, and where the AIMD consumer from this AIMD cluster is on the next lower level, where every AIMD server executes the first part of the AIMD algorithm and every consumer executes the second part of the AIMD algorithm,
wherein the first part of the AIMD algorithm is executed as follows and where N represents the level of an individual AIMD server:
if the net power P_{N} on level Nis smaller than the dynamic maximum power P_{DNmax}, that is P_{N}<P_{DNmax}, then the AIMD server on level N assigns the value 0 to control parameter c_{N} (c_{N}=0);
if P_{N}≥P_{DNmax}, then the AIMD server on level N assigns the value 1 to control parameter c_{N} (c_{N}=1),
where the value of control parameter c_{N} in the relevant time window t is sent to all AIMD consumers within this AIMD cluster,
wherein the second part of the AIMD algorithm is executed as follows:
a) if c_{N}=0 and the dynamic maximum power of the AIMD consumers on level N−1, which are connected to the AIMD server on level N, in the relevant time window P_{D(N-1)max}(t) is lower than the fixed maximum power of these AIMD consumers P_{S(N-1)max}, that is P_{D(N-1)max}(t)<P_{S(N-1)max}, then the dynamic maximum power of these AIMD consumers in the subsequent time window P_{D(N-1)max}(t+Δt) is increased by additive constant α_{(N-1)}, that is P_{D(N-1)max}(t+Δt)=P_{D(N-1)max}(t)+α_{N-1})), otherwise the power P_{D(N-1)max} does not change;
b) if c_{N}=1, the dynamic maximum power in the subsequent time window P_{D(N-1)max}(t+Δt) is decreased by using a randomly generated parameter γ_{(N-1)}, of which the random value is between 0 and 1, where the generated parameter γ_{(N-1)} is compared to the predefined probability space to determine which predefined probability space is relevant in this time window and where each probability space has a corresponding predefined multiplicative decrease factor β_{(N-1)n}, where n stands for the corresponding probability space, which is used to decrease the dynamic maximum power in the subsequent time window P_{D(N-1)max}(t+Δt), and the probability of decrease for a specific multiplicative decrease factor (β_{(N-1)n}) is calculated using the following equation:
$${P}_{D ( N - 1 ) max} ( t + Δ t ) = {P}_{D ( N - 1 ) max} ( t ) \cdot {β}_{( N - 1 ) n} ,$$
where β_{(N-1)n} is defined in relation to the probability space of the randomly generated parameter γ_{(N-1)},
wherein the value of the calculated dynamic maximum power P_{D(N-1)max}(t+Δt), which is calculated by an AIMD consumer, which belongs to an AIMD cluster on level N, represents input data for an AIMD server, which belongs to an AIMD cluster on a lower level N−1 to execute the first part of the AIMD algorithm when P_{D(N-1)max} is compared to the net power P_{(N-1)},
where the net power P_{N}, P_{N-1} on a specific level is measured using a smart meter on this level.
